(19) United States
(12) Patent Application Publication
(10) Pub. No.: US 2009/0254814 A1
(43) Pub. Date: Oct. 8, 2009

(54) PER-EDGE RULES AND CONSTRAINTS-BASED LAYOUT MECHANISM

(75) Inventors: Joseph Ting-Chun Lai, Seattle, WA (US); John Carlson, Seattle, WA (US); Miguel Gonzalez-Gongora, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/099,769

(22) Filed: Apr. 8, 2008

(51) Int. Cl. G06F 17/00; G06F 17/21

(52) U.S. Cl. 715/244; 715/243

(57) ABSTRACT

Architecture that facilitates customized object behavior by allowing for the application of layout rules and constraint on each edge of the document object. This edge-based approach can be applied to layout applications such as desktop publishing. The rules, constraints, and constraint parameters accommodate typical layout scenarios. A layout algorithm is used to find the optimal layout that satisfies a given set of constraints. The architecture provides an interaction model that allows for turning on and off constraints incrementally, per-edge, for user customization of templates. The architecture is a rules and constraint-based layout system that operates on the edge-level, where designers can specify behaviors for each edge of an object.

### BACKGROUND

The advent of the Internet serves as a catalyst for quickly elevating the hardware and software of the average user. The typical user now has a computer with office applications suitable for word processing, spreadsheets, presentations, publishing and website development. Thus, providing applications that cut across a wide base of consumers can be a challenge. Software vendors attempt to reach a wider customer base by making these applications more user-friendly through pre-designed template, forms, etc., any type of interface the user would typically expect to generate or view.

One technique for assisting the user in generating a basic document is via wizard programs. For example, a publishing application can include a wizard system where desktop publishing templates are provided that adapt to the amount of user content while allowing extensive customization applied to the template. However, as user requirements change, the wizards do not evolve sufficiently quickly to accommodate these user requirements. The production process for changing wizards can be very slow and costly. Each design requires different smart behaviors to adapt to user content, and the production process also requires developers to write custom code for each design. There are constraint-based layout applications; however, none of the constraint-based layout systems (e.g., cascading style sheet (CSS) for web publishing) can satisfy the specific needs of desktop publishing.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture facilitates customized object behavior by allowing for the application of layout rules and constraint on each edge of the document object. More specifically, this edge-based approach can be applied to layout applications such as desktop publishing. The rules, constraints, and constraint parameters accommodate typical layout scenarios. A layout algorithm is used to find the optimal layout that satisfies a given set of constraints. The architecture provides an interaction model that allows for turning on and off constraints incrementally, per-edge, for user customization of templates. User customization is not reverted afterwards.

The architecture is a rules and constraints-based layout system that operates on the edge-level, where designers can specify behaviors for each edge of an object, in contrast to the conventional per-object approach. The layout system can be applied to desktop publishing templates and specific rules and constraints designed that are suitable for desktop publishing needs. In addition, an algorithm is provided that finds layouts that satisfy a given set of rules and constraints.

To the accomplishment of the foregoing and related ends, certain illustrative aspects are described herein in connection with the following description and the annexed drawings. These aspects are indicative of the various ways in which the principles disclosed herein can be practiced, all aspects and equivalents of which are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented layout system in accordance with the architecture.

FIG. 2 illustrates a publishing application that employs the system of FIG. 1.

FIG. 3 illustrates an example of edge-based control of objects in a document.

FIG. 4 illustrates an exemplary workflow for a template designer.

FIG. 5 illustrates an exemplary workflow for a user that uses the template designed in FIG. 4.

FIG. 6 illustrates a method of processing objects in a layout application.

FIG. 7 illustrates a detailed method of processing objects in a document for layout.

FIG. 8 illustrates with the method of processing objects in a document initiated in FIG. 7.

FIG. 9 illustrates a method of layout processing of an object set in a document.

FIG. 10 illustrates a block diagram of a computing system operable to execute layout processing on a per-edge basis in accordance with the disclosed architecture.

### DETAILED DESCRIPTION

The disclosed architecture provides a granular interaction approach to object layout in documents for layout applications. Rules and constraints are applied per-edge of each object in the document. For example, a designer can author and user can customize a template that resizes and moves edges based on user content, by implementing custom behavior on every edge for all document objects. To provide customizability on the templates, users can customize every part of a template. As users make changes, constraints and/or rules can be turned off on the tempered edge to avoid reverting user actions.

The layout system can be applied to desktop publishing templates and specific rules and constraints designed that are suitable for desktop publishing needs. In addition, an algorithm is provided that finds layouts that satisfy a given set of rules and constraints.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives falling within the spirit and scope of the claimed subject matter.

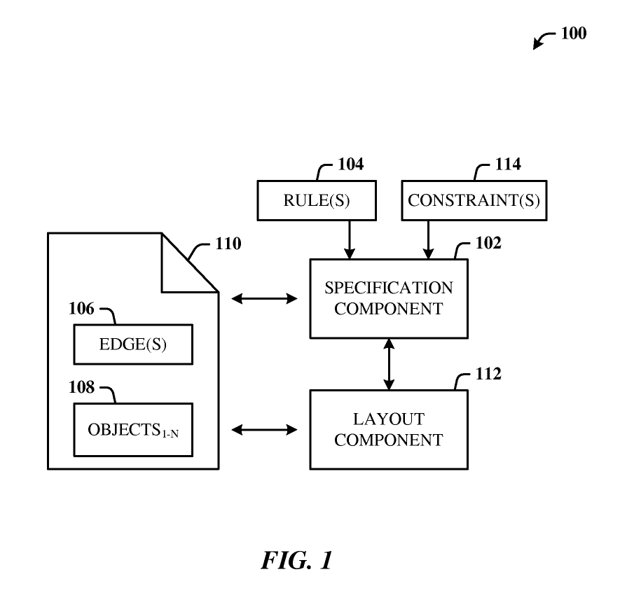

FIG. 1 illustrates a computer-implemented layout system 100 in accordance with the architecture. The system 100 includes a specification component 102 for specifying one or more rules 104 to edges 106 of objects 108 in a document 110. The objects 108 include image content and textual content, for example. The system 100 can also include a layout component 112 for processing the one or more rules 104 on a per-edge basis to find an optimal layout for the objects 108 in the document 110.

The specification component 102 and layout component 112 can be employed in different layout applications such as a desktop publishing application. The one or more rules 104 associated with an object are processed according to priority criteria based on object interference. The specification component 102 further specifies constraints 114 for processing on the per-edge basis of the object. The layout component 112 facilitates interaction to incrementally turn off constraints a per-edge basis. The constraints 114 can be applied in association with the rules 104.

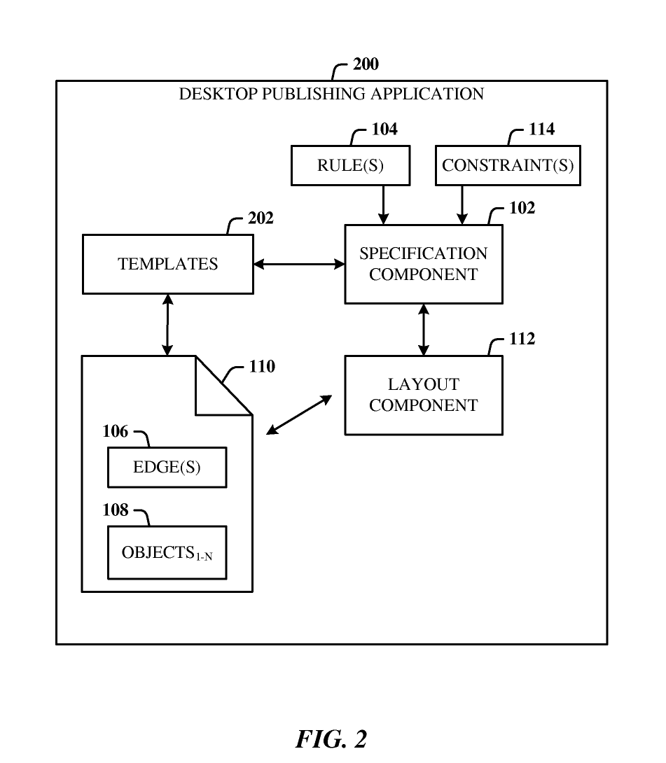

FIG. 2 illustrates a publishing application 200 that employs the system 100 of FIG. 1. The publishing application 200 is one type of layout application that can benefit from the disclosed architecture. Another can be a presentation application. In addition to including the entities of the system 100, the publishing application 200 can further include one or more customizable templates 202 that a user can customize. Rules and constraints for the templates 202 can be specified by the specification component 102. The layout component 112 allows the user to turn off rules and/or constraints associated with an object edge based on the customization process.

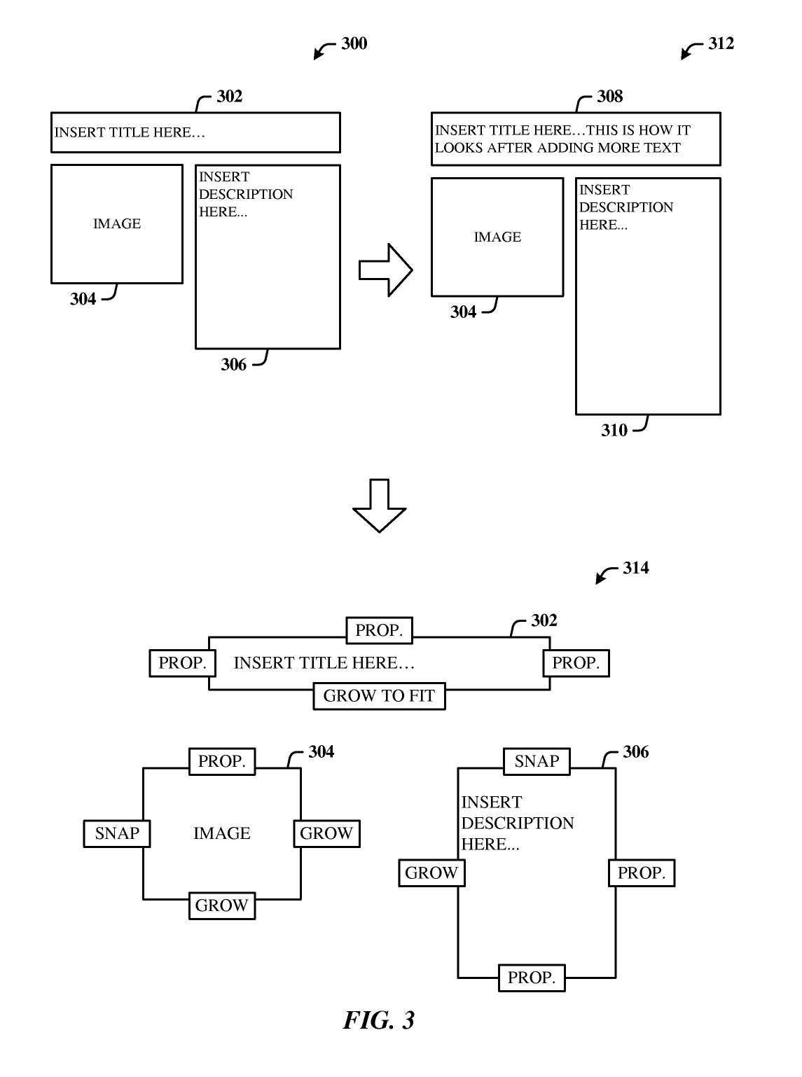

FIG. 3 illustrates an example of edge-based control of objects in a document. Consider that a user is authoring a template that can resize and move edges based on user content. The user may want to change the image 304 or type more text in the text objects (or boxes). To accommodate these changes while keeping the layout aesthetically pleasant, elements on the page need to be moved and resized to an adequate size to accommodate the content, and the right position to preserve the alignment and balance.

A first object set 300 includes a title object 302, image object 304, and description object 306. Adding textual content to the title object 302 changes the dimensions of the title object 302 into a modified title object 308, and the dimensions of the description object 306 are changed in the vertical dimension thereby creating the modified description object 310, resulting in the modified object set 312. The modified title object 308, in this example, pushes the image object 304 and the modified description object 310 down to accommodate for expansion of the modified title object 308, while maintaining constant spacing between title object 308 and description object 310/image object 304, which is desired in graphic design.

The object set 314 shows the implementation of per-edge rules and/or constraints for the objects to achieve the behavior results of the object set 312. Each object in the object set (or group) 314 (previously the object set 300) has rules applied, at least one rule per edge. The rules specify relative position behavior for the edge as the object set is resized. Here, the title object 302 has a proportional (PROP) rule applied to the left, top and right edges, and a “grow-to-fit” rule applied to the bottom edge. The image object 304 has a proportional rule applied to the top edge, a snap (SNAP) rule applied to the left edge, and grow (GROW) rules applied to the right and bottom edges. The description object 306 has a snap rule applied to the top edge, a grow rule applied to the left edge, and proportional rules applied to the right and bottom edges. The disclosed architecture is capable of interpreting these rules, and producing a new layout each time the user customizes the template.

Following is a table of per-edge rules that can be applied. It is to be understood that this is not an exhaustive list as the designer can include other rules and rule behaviors as desired.

| Rule | Behavior |
|---|---|
| Fixed | Edge maintains an absolute offset from one of the reference |
| | points within the object. |
| Proportional | Edge moves proportionally as the object resizes. |
| Grow | Extend the edge to fit content or fill available space. |
| Snap | The snapping edge follows the target edge if it moves |
| | during a layout refresh. |
| Original Size | Moves the edge in tandem with the opposing edge, so |
| | the shape keeps its original width/height. |
| . . . | . . . |

The rules also have an implicit priority that assists in resolving object position as the object bounds interfere with the bounds of other objects in the group (or object set).

The rules also carry associated implied constraints, which assist in ensuring that the resulting layout is suitable. In addition, the objects may have been assigned explicit constraints, such as “preserve aspect ratio.” Following is a table of per-object constraints that can be employed. This is also not an exhaustive list. Other possible constraint types can include: color, position, content in placeholder, etc.

| Constraint | Behavior |
|---|---|
| Lock aspect | If this flag is true, our layout engine will only grow/ |
| ratio | shrink the shape if the aspect ratio can be preserved. |
| Minimum | Self-explanatory |
| width | |
| Minimum | Self-explanatory |
| height | |
| Avoid text | As a shape grows, it can cause text box to go into overflow. |
| overflow | This constraint will stop the shape from growing if |
| | growing further will cause any text box that it's overlapping |
| | with to enter overflow. |
| Avoid | As a shape grows, it can cause text to be too narrow |
| narrow | to read or even create an undesired empty space. To avoid |
| text | this situation, the grow rule will stop growing when it hits |
| | the threshold that leaves too little room for the text. |
| . . . | . . . |

In one implementation, the rules and/or constraints are not exposed to the end user. However, in an alternative implementation, the end-user can access the rule and/or constraints, modify the existing set and/or add new rules and constraints.

In one example, the rules are resolved using the following method, when the object set (or group) is either created or updated in some way that initiates an updated layout, for instance, when the object set is resized.

The layout is achieved using multiple layout passes, and there exists layout state that accumulates with each pass. The objects in the group are first scaled to a “proportional” layout position. This ensures that the subsequent steps produce consistent results for any previous layout conditions. The layout state is set to “initial” and then a layout pass (explained in the next paragraph) is run. Next, the layout state is incremented and another layout pass is run. This is repeated several times, incrementing the layout state each time. If the layout is not complete (e.g., if not all constraints are satisfied), one or more additional layout passes can be run, with the state set to “contingency” (which means the system begins to compromise on low priority constraints during the layout pass).

Each layout pass includes of the following steps. Note that the decisions made at each step are governed in part by the current layout state, in addition to each object size, position, and content. First, grow shapes that have “grow” rules set. In other words, if a shape has one or more edges with the “grow” rule, and the shape has a content type that could benefit from more room, then an attempt is made to grow the shape using the layout push method described below. Next, an attempt is made to repair violations of the implicit and explicit layout constraints. In priority order, fix the aspect ratio, the text-fix, incorrectly overlapping objects, etc.

In the layout push process referred to above, frequent adjustment is made to the size of an object. However, that object may have neighbors that are not desirable to move. However, if the first object represents a high-priority layout problem, the second object would be able to move after all. This type of layout reconciliation is handled using the layout push. An object is considered “pushing” if the object is the primary object being laid out. For instance, if a textbox object does not have room for all its textual content in the current object dimensions, it may be desired to make the object larger. The object then performs a push in one or more directions (e.g., each of four directions). The object will push with a particular priority as a parameter, depending on the problem trying to be fixed. Text in overflow is a high priority, while making an image larger and more attractive is a lesser priority.

When an object is pushed against, the recipient object (or shape) makes a decision whether to comply with the request based on the pushing object's priority. If the pushing object has a lower priority but the recipient object is a textbox in overflow, the recipient object will push back and not comply with the push. If, however, the pushing object has a higher priority, then the recipient object will resize itself and acknowledge that to the pushing object that the recipient object has made room.

Sometimes a recipient object to a push will be able to comply only partially. For instance, an image may be close to its minimum size and can shrink only so far. In this case, the image object will acknowledge a partial resize. In all cases of incomplete compliance with a push, the pushing object will pass-on the push to the next object in the pushed direction, since the next object may be able to shrink as well, completing the request of the pushing shape. A result is that a high-priority object layout will override the position of a lower priority object.

Multiple passes can be performed with each push request. These passes use gradually increasing priorities up to the pushing object priority. However, if an image object pushes with priority—1, and followed by a neighbor object with priority—2, but with a further neighbor object with priority—3, in this case, the first push is performed with the priority—3 neighbor object, meaning the correct object is made to resize itself.

Note that as objects are pushing and being pushed against, the objects are resized in a way that does not violate the layout constraints associated with the object rules. In other words, every object adjustment made maintains the basic requirements of object minimum size, aspect ratio, fixed sizes, etc.

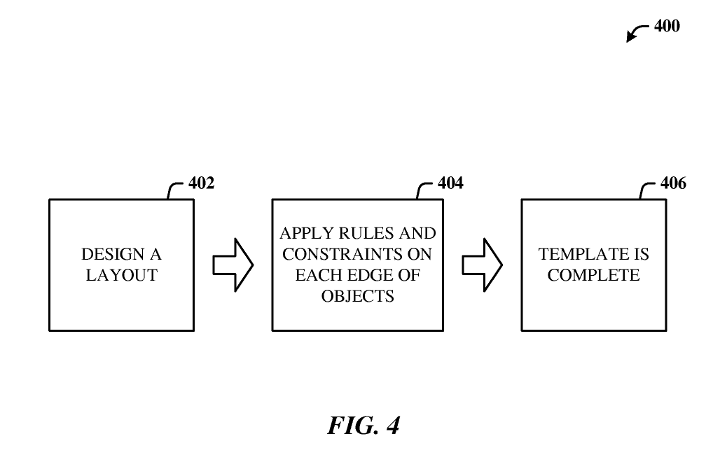

FIG. 4 illustrates an exemplary workflow 400 for a template designer. The workflow 400 begins with the designer designing a layout of objects, at 402. At 404, the designer applies rules and constraints on each edge of the objects. At 406, the template is completed.

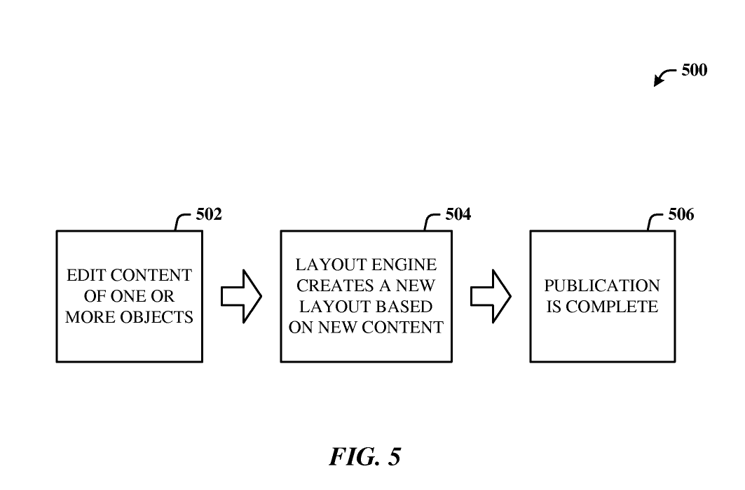

FIG. 5 illustrates an exemplary workflow 500 for a user that uses the template designed in FIG. 4. The workflow 500 begins with the user editing the content of one or more objects. At 504, the layout engine creates a new layout based on the new object content. In other words, a layout “refresh” process can be initiated after the user changes the content. Content can be considered a constraint. At 506, publication is complete.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

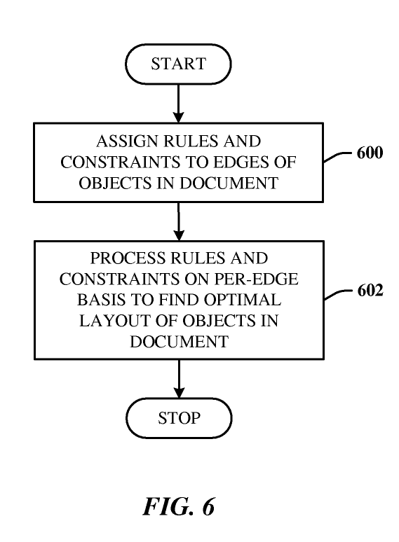

FIG. 6 illustrates a method of processing objects in a layout application. At 600, rules and constraints are assigned to edges of objects in a document. At 602, the rules and the constraints are processed on a per-edge basis to find an optimal layout for the objects in the document.

Other method steps can include overriding default template edge settings with customized settings during template customization and interpreting the rules and constraints to automatically preserve object alignment and balance in the document based in part on content changes in one or more of the objects. Behaviors are specified for each of the rules and constraints and the behaviors applied to templates of a desktop publishing application.

The processes described herein can include executing a layout pass on the objects, accumulating layout state for the layout pass, and repeatedly executing additional layout passes and accumulating the layout state until all constraints are satisfied. An object can be pushed in one or more directions in response to receiving an increased amount of textual content, and based on a priority parameter associated with a constraint. The pushing object initiates a push request that is processed by a recipient object, and the recipient object determined whether to comply with the push request and give up space or to deny the push request. The method can further include assigning priorities to a push object and multiple recipient objects for layout processing, and performing the layout processing according to the priorities, and specifying relative position behavior of an edge via a rule as a set of the objects is resized, resolving an edge position as object bounds interfere with other objects and, processing implicit and explicit constraints of the object.

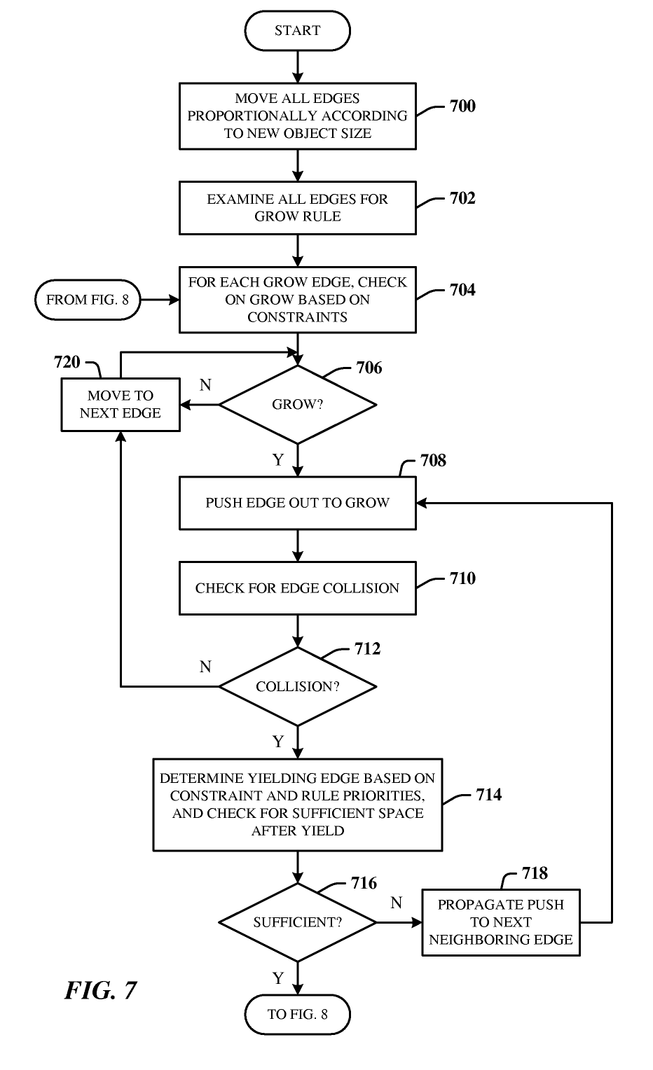

FIG. 7 illustrates a detailed method of processing objects in a document for layout. At 702, all edges of an object are moved according to a new object size. At 702, all edges are then examined for a grow rule. At 704, for each grow edge, a check is made to determine if the edge is to grow based on the associated constraints. At 706, if yes, flow is to 708 to push the edge out to grow. At 710, a check is made for a boundary collision. At 712, if there is a collision, flow is to 714 to determine a yielding edge based on constraint and rule priorities, and then check for sufficient space after the edge has yielded. If there is no sufficient space, at 716, flow is to 718 to propagate the push to the next neighboring edge. Flow is then back to 708 to push the edge to grow. If, at 712, there is no collision, flow is to 720 to move to the next edge, and then to 706 to continue the process.

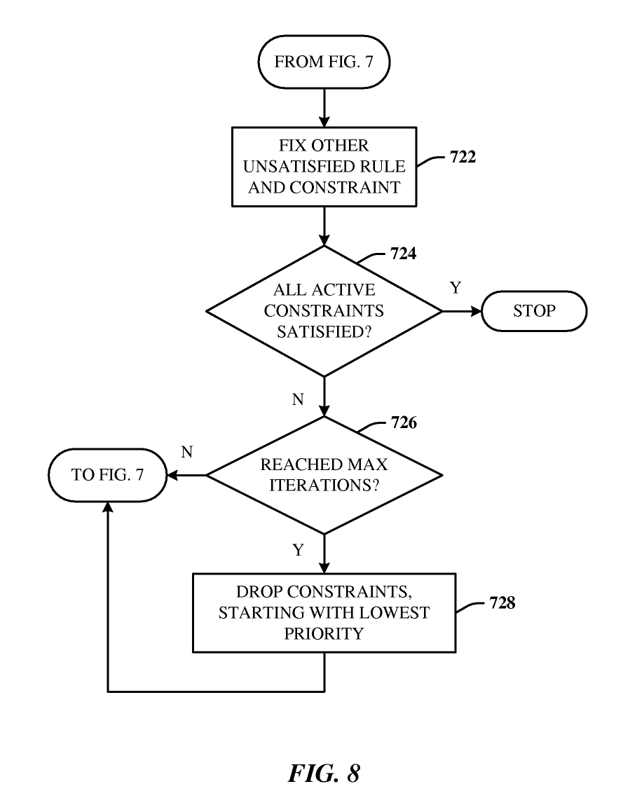

FIG. 8 continues with the method of processing objects in a document initiated in FIG. 7. If there is insufficient space, as checked at 716, flow is to 722 of FIG. 8 fix other unsatisfied rules and constraints. At 724, the method checks if all active constraints are satisfied, and if so, the method can stop. If not, flow is from 724 to 726 to check if the maximum number of iterations have executed. If yes, flow is to 728 drop the constraints, starting with the lowest priority. Flow is then back to 704 of FIG. 7 to grow another edge based on constraints for that edge. Likewise, flow is from 728 to 704. This method continues until all edges and objects are processed.

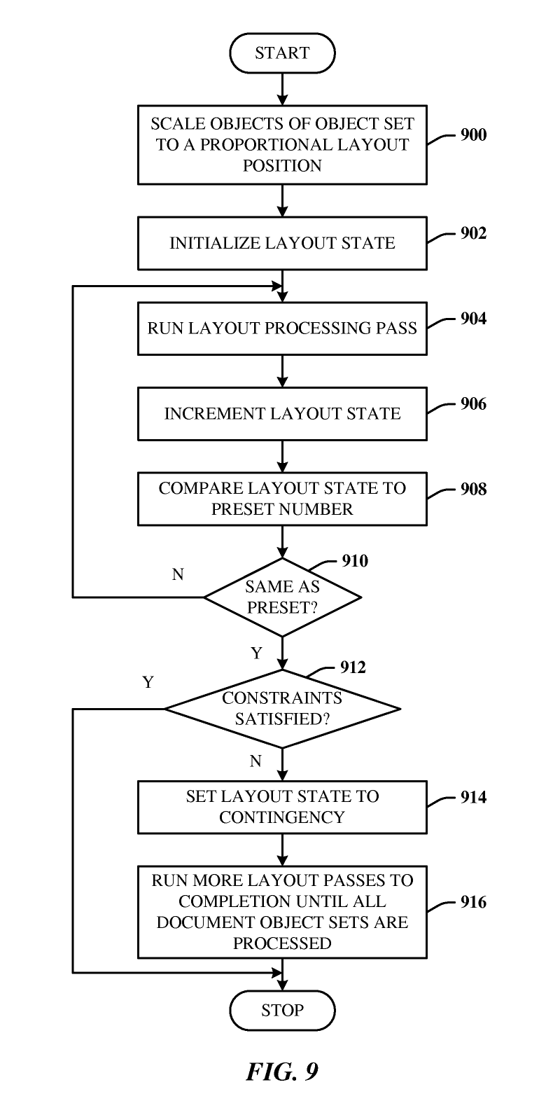

FIG. 9 illustrates a method of layout processing of an object set in a document. At 900, the objects of the objects set are scaled to a proportional layout position. At 902, layout state is initialized. At 904, a layout processing pass is run. At 906, the layout state is incremented (or accumulated). At 908, the layout state is compared to a preset number to determine if the process is done. If not, flow is from 910 back to 904 to run another processing pass. When the layout state equals the preset number, flow is from 910 to 912 to check if the constraints have been satisfied. If yes, the process stops. If no, flow is from 912 to 914 to set the layout state to contingency. At 916, one or more additional layout passes are run until all objects are processed., and flow is back to 904 to continue with another layout processing run.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

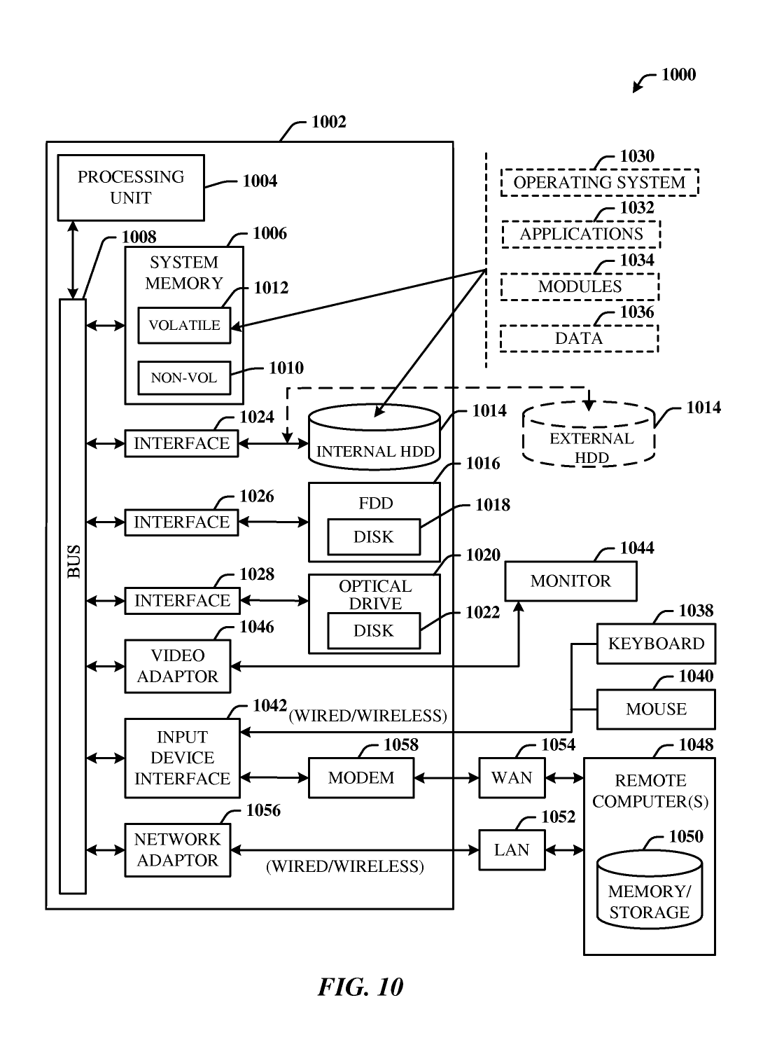

Referring now to FIG. 10, there is illustrated a block diagram of a computing system 1000 operable to execute layout processing on a per-edge basis in accordance with the disclosed architecture. In order to provide additional context for various aspects thereof, FIG. 10 and the following discussion are intended to provide a brief, general description of a suitable computing system 1000 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 10, the exemplary computing system 1000 for implementing various aspects includes a computer 1002 having a processing unit 1004, a system memory 1006 and a system bus 1008. The system bus 1008 provides an interface for system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 can include non-volatile memory (NON-VOL) 1010 and/or volatile memory 1012 (e.g., random access memory (RAM)). A basic input/output system (BIOS) can be stored in the non-volatile memory 1010 (e.g., ROM, EPROM, EEPROM, etc.), which BIOS are the basic routines that help to transfer information between elements within the computer 1002, such as during start-up. The volatile memory 1012 can also include a high-speed RAM such as static RAM for caching data.

The computer 1002 further includes an internal hard disk drive (HDD) 1014 (e.g., EIDE, SATA), which internal HDD 1014 may also be configured for external use in a suitable chassis, a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as a DVD). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 1012, including an operating system 1030, one or more application programs 1032, other program modules 1034, and program data 1036. The one or more application programs 1032, other program modules 1034, and program data 1036 can include the specification component 102, rules 104, edges 106, objects 108, document 110, layout component 112, constraints 114, desktop publishing application 200, templates 202, object set 314, workflow 400, workflow 500, and so on.

All or portions of the operating system, applications, modules, and/or data can also be cached in the volatile memory 1012. It is to be appreciated that the disclosed architecture can be implemented with various commercially available operating systems or combinations of operating systems.

A user can enter commands and information into the computer 1002 through one or more wire/wireless input devices, for example, a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces such as a parallel port, IEEE 1394 serial port, a game port, a USB port, an IR interface, etc.

A monitor 1044 or other type of display device is also connected to the system bus 1008 via an interface, such as a video adaptor 1046. In addition to the monitor 1044, a computer typically includes other peripheral output devices (not shown), such as speakers, printers, etc.

The computer 1002 may operate in a networked environment using logical connections via wire and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wire and/or wireless device, is connected to the system bus 1008 via the input device interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented layout system, comprising:
a specification component for specifying rules to edges of objects in a document; and
a layout component for processing the rules on a per-edge basis to find an optimal layout for the objects in the document.

2. The system of claim 1, wherein the specification component and layout component are employed in a desktop publishing application.

3. The system of claim 1, wherein the rules associated with an object are processed according to priority criteria based on object interference.

4. The system of claim 1, wherein the specification component further specifies constraints for processing on the per-edge basis of an object.

5. The system of claim 4, wherein the rules and constraints are processed based a change associated with content of the object, the content includes at least one of image content or textual content.

6. The system of claim 1, wherein the layout component facilitates interaction to incrementally turn off constraints a per-edge basis, the constraints applied in association with the rules.

7. The system of claim 1, wherein the rules include behavior related to moving an edge proportionally, extending the edge, maintaining an absolute offset from a reference point, following a target edge during a refresh process, and moving an edge in tandem with an opposing edge.

8. A computer-implemented layout system, comprising:
a specification component of a desktop publishing application for specifying rules and constraints to edges of objects in a document; and
a layout component of the desktop publishing application for processing the rules and the constraints on a per-edge basis to find an optimal layout for the objects in the document.

9. The system of claim 8, wherein the layout component allows for incrementally turning off constraints per-edge for customization of a template.

10. The system of claim 8, wherein the constraints include behavior related to at least one of locking aspect ratio, setting a minimum width, setting a maximum height, avoid text overflow, or avoiding narrow text.

11. The system of claim 8, wherein the layout component employs a layout push method for pushing objects based in part on object priorities.

12. The system of claim 11, wherein the push method resizes pushing objects and recipient objects so as to conform to the constraints and associated rules.

13. A computer-implemented method of processing objects in a layout application, comprising:
assigning rules and constraints to edges of objects in a document; and
processing the rules and the constraints on a per-edge basis to find an optimal layout for the objects in the document.

14. The method of claim 13, further comprising overriding default template edge settings with customized settings during template customization and interpreting the rules and constraints to automatically preserve object alignment and balance in the document based in part on content changes in one or more of the objects.

15. The method of claim 13, further comprising specifying behaviors for each of the rules and constraints and applying the behaviors to templates of a desktop publishing application.

16. The method of claim 13, further comprising executing a layout pass on the objects, accumulating layout state for the layout pass, and repeatedly executing additional layout passes and accumulating the layout state until all constraints are satisfied.

17. The method of claim 13, further comprising pushing an object in one or more directions in response to receiving an increased amount of textual content, and based on a priority parameter associated with a constraint.

18. The method of claim 13, further comprising processing a push request by a recipient object, the recipient object determining whether to comply with the push request and give up space or to deny the push request.

19. The method of claim 13, further comprising assigning priorities to a push object and multiple recipient objects for layout processing, and performing the layout processing according to the priorities.

20. The method of claim 13, further comprising specifying relative position behavior of an edge via a rule as a set of the objects is resized, resolving an edge position as object bounds interfere with other objects and, processing implicit and explicit constraints of the object.
